(19) United States
(12) Patent Application Publication
(10) Pub. No.: US 2015/0112649 A1
(43) Pub. Date: Apr. 23, 2015

(54) Clustering Lithographic Hotspots Based on Frequency Domain Encoding

(71) Applicant: International Business Machines Corporation, Armonk, NY (US)

(72) Inventors: Kanak B. Agarwal, Austin, TX (US); Shayak Banerjee, Austin, TX (US)

(73) Assignee: International Business Machines Corporation, Armonk, NY (US)

(21) Appl. No.: 14/057,588

(22) Filed: Oct. 18, 2013

(51) Int. Cl. G06F 17/50; G06F 17/14

(52) U.S. Cl. CPC G06F 17/5009; G06F 17/14
USPC 703/2

(57) ABSTRACT

A mechanism is provided in a data processing system for clustering lithographic hotspots based on frequency domain encoding. The mechanism receives a design layout and generates spatial pattern clips from the design layout. The mechanism performs a transform on the spatial pattern clips to form frequency domain pattern clips and performs feature extraction on the frequency domain pattern clips to form frequency domain features. The mechanism clusters the frequency domain features into a plurality of clusters and identifying a set of hotspot clusters within the plurality of clusters. Each hotspot cluster can be used to drive a fixing action such as change in RET or ground rules, without having to process each individual hotspot, thus greatly reducing technology development efforts.

### BACKGROUND

The present application relates generally to an improved data processing apparatus and method and more specifically to mechanisms for clustering lithographic hotspots based on frequency domain encoding.

Optical lithography is a crucial step in semiconductor manufacturing. The basic principle of optical lithography is quite similar to that of chemistry-based photography. The images of the patterned photo-mask are projected through the high-precision optical system onto the wafer surface, which is coated with a layer of light-sensitive chemical compound, e.g. photo-resist. The patterns are then formed on the wafer surface after complex chemical reactions and follow-on manufacturing steps, such as development, post-exposure bake, and wet or dry etching.

Low k₁ lithography presents significant printability challenges for 22 nm technology. Design rules must guarantee manufacturable layouts over all possible enumerations of the design rule checker (DRC) clean shapes. The number of rules must be within a practical limit while still covering a wide range of complex two-dimensional optical interactions.

A lithographic hotspot is an area of the design that is likely to produce a printing error. The number of lithographic hotspots is growing exponentially with further scaling into low k₁ photolithography. Lithographic hotspots are most prominent in bi-directional layers like lx metal. Hotspots cause design/process churn. It is critical to identify and eliminate hotspots early in the design process to reduce design/manufacturing costs.

### SUMMARY

In one illustrative embodiment, a method, in a data processing system, is provided for clustering lithographic hotspots based on frequency domain encoding. The method comprises receiving a design layout. The method further comprises generating spatial pattern clips from the design layout. The method further comprises performing a transform on the spatial pattern clips to obtain frequency domain information for the pattern. The method further comprises performing feature extraction on the frequency domain pattern clips to form frequency domain features. The method further comprises clustering the frequency domain features into a plurality of clusters. The method further comprises identifying a set of hotspot clusters within the plurality of clusters.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram of an example data processing system in which aspects of the illustrative embodiments may be implemented;

FIG. 2 illustrates an example design that may violate rules resulting in a hotspot;

FIG. 3 illustrates an example of spatial clustering of clips;

FIG. 4 is a block diagram illustrating a traditional flow for a hotspot clustering mechanism in accordance with one embodiment;

FIG. 5 is a block diagram illustrating a flow for a hotspot clustering mechanism based on frequency domain coding in accordance with an illustrative embodiment;

FIG. 6 illustrates a hotspot clip in the spatial domain in accordance with an illustrative embodiment;

FIG. 7 illustrates a hotspot clip in the frequency domain in accordance with the illustrative embodiment;

FIG. 8 illustrates an extracted feature vector in accordance with the illustrative embodiment;

FIG. 9 illustrates raw data being clustered into hotspot clusters in accordance with the illustrative embodiment

FIGS. 10A and 10B illustrate a centered hotspot clip and a shifted hotspot clip in accordance with an example embodiment;

FIG. 11 illustrates an XOR between the centered clip and the shifted clip in accordance with the example embodiment;

FIG. 12 illustrates an example of a known hotspot in accordance with an example embodiment;

FIG. 13 illustrates an example new layout for which the frequency domain pattern may match the known hotspot in accordance with the example embodiment;

FIG. 14 is a block diagram illustrating frequency domain pattern matching using frequency based clustering in accordance with an illustrative embodiment; and

FIG. 15 is a flowchart illustrating operation of a mechanism for clustering lithographic hotspots based on frequency domain encoding in accordance with an illustrative embodiment.

### DETAILED DESCRIPTION

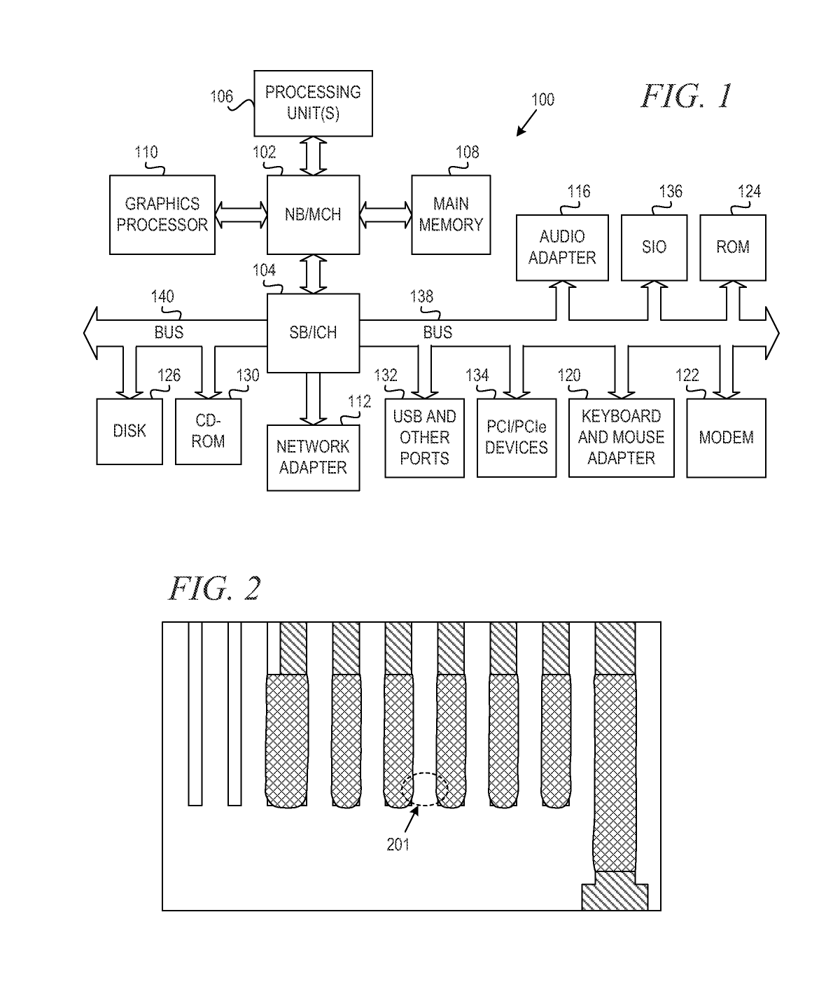

The illustrative embodiments may be utilized in many different types of data processing environments. In order to provide a context for the description of the specific elements and functionality of the illustrative embodiments, FIG. 1 is provided as an example environment in which aspects of the illustrative embodiments may be implemented. It should be appreciated that FIG. 1 is only an example and is not intended to assert or imply any limitation with regard to the environments in which aspects or embodiments of the present invention may be implemented. Many modifications to the depicted environments may be made without departing from the spirit and scope of the present invention.

FIG. 1 is a block diagram of an example data processing system in which aspects of the illustrative embodiments may be implemented. Data processing system 100 is an example of a computer in which computer usable code or instructions implementing the processes for illustrative embodiments of the present invention may be located. In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106. The operating system coordinates and provides control of various components within the data processing system 100 in FIG. 1. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 100.

As a server, data processing system 100 may be, for example, an IBM® eServer™ System P® computer system, running the Advanced Interactive Executive (AIX®) operating system or the LINUX® operating system. Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for illustrative embodiments of the present invention may be performed by processing unit 106 using computer usable program code, which may be located in a memory such as, for example, main memory 108, ROM 124, or in one or more peripheral devices 126 and 130, for example.

A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the SMP system mentioned previously, without departing from the spirit and scope of the present invention.

Moreover, the data processing system 100 may take the form of any of a number of different data processing systems including client computing devices, server computing devices, a tablet computer, laptop computer, telephone or other communication device, a personal digital assistant (PDA), or the like. In some illustrative examples, data processing system 100 may be a portable computing device that is configured with flash memory to provide non-volatile memory for storing operating system files and/or user-generated data, for example. Essentially, data processing system 100 may be any known or later developed data processing system without architectural limitation.

An accepted way of identifying hotspots is through lithography simulation over a dose/focus process window followed by optical rule check (ORC) on lithographic contours to identify violations of minimum space, minimum width, etc. FIG. 2 illustrates an example design that may violate rules resulting in a hotspot. For example, area 201 represents a hotspot, because the lithographic contours violate minimum space rules. In the extreme case, with focus and dose variation, the lithographic contours of adjacent shapes may merge into each other leading to shorts or bridging errors. Similarly, lithographic process variation can also lead to a scenario where some part of a design shape does not print at all on the wafer thereby leading to opens or pinching errors.

In the early technology development stage, the above process of hotspot identification may lead to identifying a very large number (can be in the range of 100,000) hotspots on a single level. It is very difficult to manually review each hotspot. Many hotspots are similar to each other. Some form of clustering or grouping allows one to look at groups of similar hotspots instead of a single hotspot. Clustering improves efficiency of review and reporting. Clustering focuses triage activity on a hotspot “type” instead of a single hotspot.

Prior art hotspot clustering is performed on spatial data. As an example, prior art clustering techniques may perform an XOR operation between layout clips to determine similarity of polygons. However, clustering based on spatial data has certain disadvantages. Polygons near clip boundaries can cause large differences in the XOR metric. Also, the XOR metric is not robust to pattern shifts, rotations, or reflections. Other spatial metrics have the same issues.

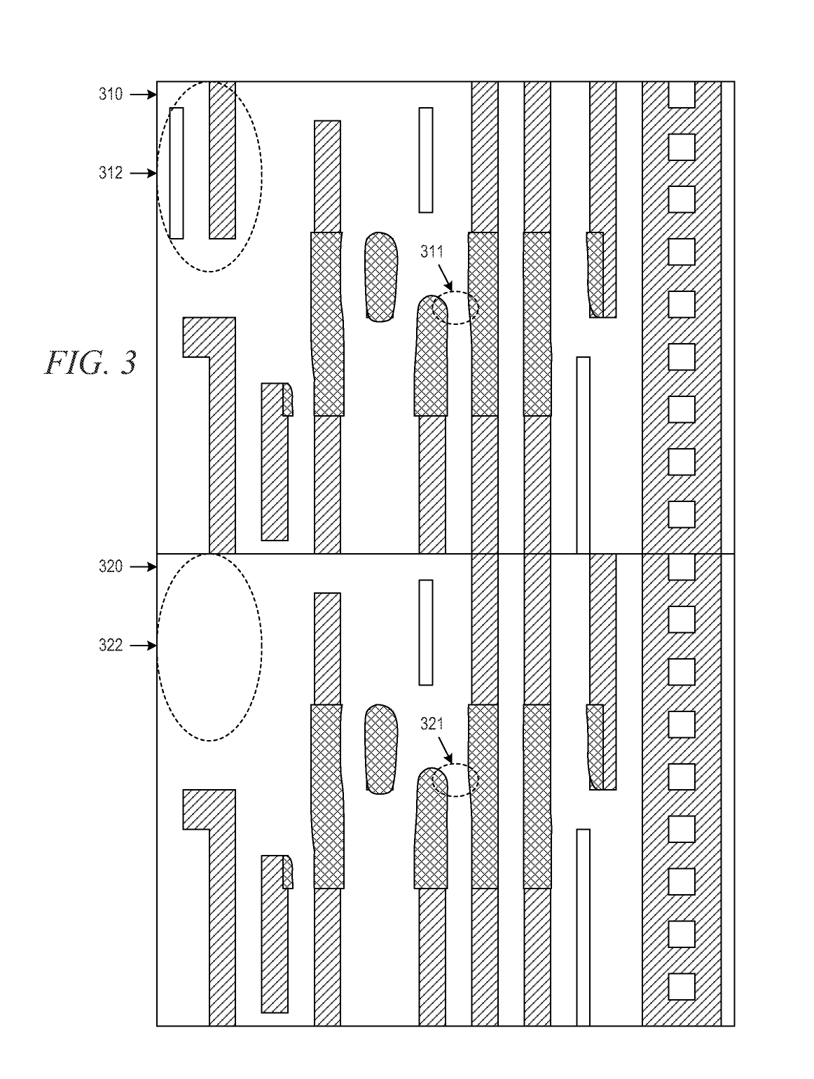

FIG. 3 illustrates an example of spatial clustering of clips. Clip 310 has hotspot 311, and clip 320 has hotspot 321. An XOR metric would likely determine that clip 310 and clip 320 are different, because clip 310 has features in area 312, while clip 320 does not have features in area 322, even though the hotspot exists in both clips and, in all likelihood, is caused by the same underlying phenomenon.

The illustrative embodiments provide mechanisms for clustering lithographic hotspots based on frequency domain encoding. The mechanisms perform clustering of hotspots based on diffraction pattern, as opposed to spatial domain representation. A diffraction pattern consists of diffraction orders, each of which interacts differently with the lithographic system. Certain diffraction orders are problematic for the lithographic system to print. The mechanisms use clustering results to identify a physical source of hotspot (problematic diffraction orders) for each cluster. The mechanism applies ground rule changes or resolution enhancement technology (RET) optimizations (e.g., source optimization or sub-resolution assist feature (SRAF) insertion) for each cluster based on problematic diffraction orders.

Frequency domain clustering is physically relevant. Furthermore, a key advantage of frequency domain encoding is that frequency domain clustering is not affected by pattern shifts in the spatial domain. The equation for a one-dimensional Fourier transform of a function, x(t), is as follows:

ℑ[x(t±t₀)]=X(jω)e^{±jωt}^{₀},
where t₀ is a shift in the spatial domain, X(jω) is the frequency domain representation of x(t) before shift. The additional term exp(±jωt₀) in the frequency domain representation due to spatial domain pattern shift only impacts the phase of the function. The magnitude of frequency domain information does not change with spatial shifts or pattern translation, rotation, or reflection.

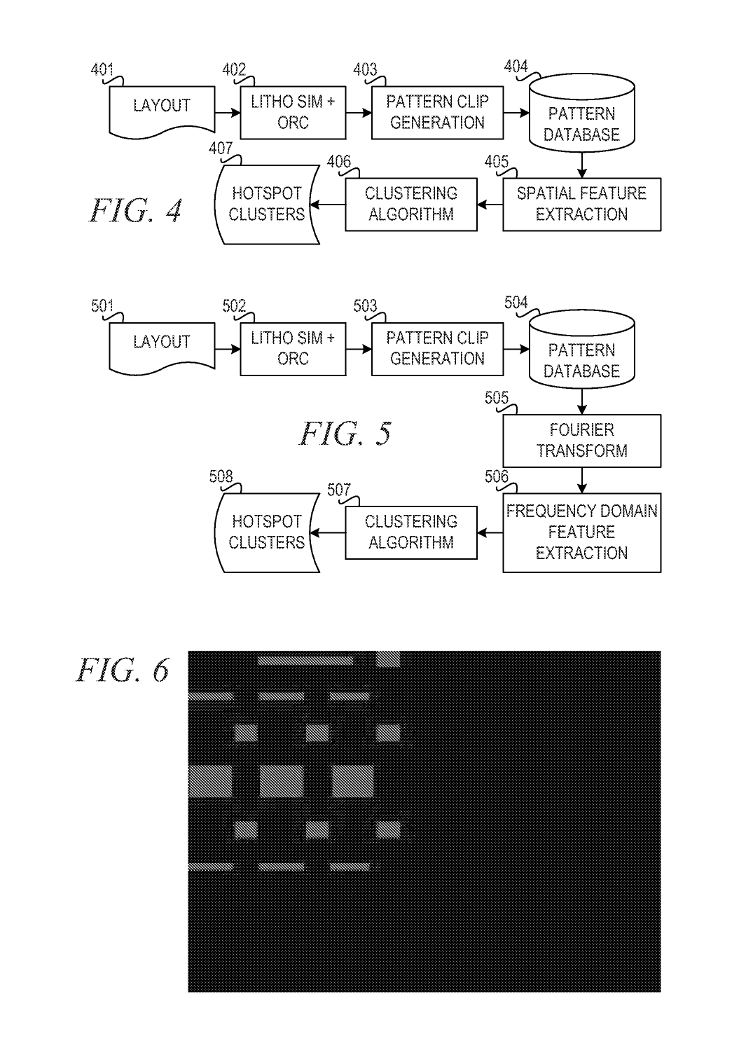

FIG. 4 is a block diagram illustrating a traditional flow for a hotspot clustering mechanism in accordance with one embodiment. The mechanism receives layout 401 and performs lithography simulation and optical rule check (ORC) 402 on the layout. The mechanism then performs pattern clip generation 403 and stores the clips in pattern database 404. The mechanism then performs spatial feature extraction 405 and performs a clustering algorithm 406 on the spatial features. The clustering algorithm 406 generates hotspot clusters 407.

FIG. 5 is a block diagram illustrating a flow for a hotspot clustering mechanism based on frequency domain coding in accordance with an illustrative embodiment. The mechanism receives layout 501 and performs lithography simulation and optical rule check (ORC) 502 on the layout. The mechanism then performs pattern clip generation 503 and stores the clips in pattern database 504.

The mechanism then performs a Fourier transform 505 on the clips to convert the clips into frequency domain clips. The mechanism performs frequency domain feature extraction 506 and performs a clustering algorithm 507 on the frequency domain features. The clustering algorithm 507 generates hotspot clusters 508.

One of the key benefits of frequency domain clustering is that it captures the underlying physical cause of lithographic hotspots. In diffraction limited optics, the diffraction pattern (frequency domain representation) of the layout determines the lithographic response. Clustering hotspots based on spatial domain information is not a physically sound scheme because it is possible to have multiple different spatial layouts that result in similar hotspots due to similar spatial frequency terms present in the layout. Spatial domain grouping leads to more clusters than are physically relevant, and hence increases review and triage time. Problematic spatial frequency terms (diffraction orders) are usually the root cause of hotspots and hence a clustering scheme based on frequency domain encoding can usually provide better insight into hotspot problems. Once a cluster of similar hotspots is identified, triage activity can be focused around eliminating problematic diffraction orders. For example, the illumination source can be re-optimized for certain clusters. The source optimization may be performed in the frequency domain to ensure that certain diffraction orders are captured by the objective lens in the lithographic system. Mask optimization recipes such as SRAF insertions can also be re-optimized to modify diffraction patterns. Finally, if a set if hotspots can not be eliminated by the RET steps, then ground rules can be modified to eliminate certain patterns from occurring on design.

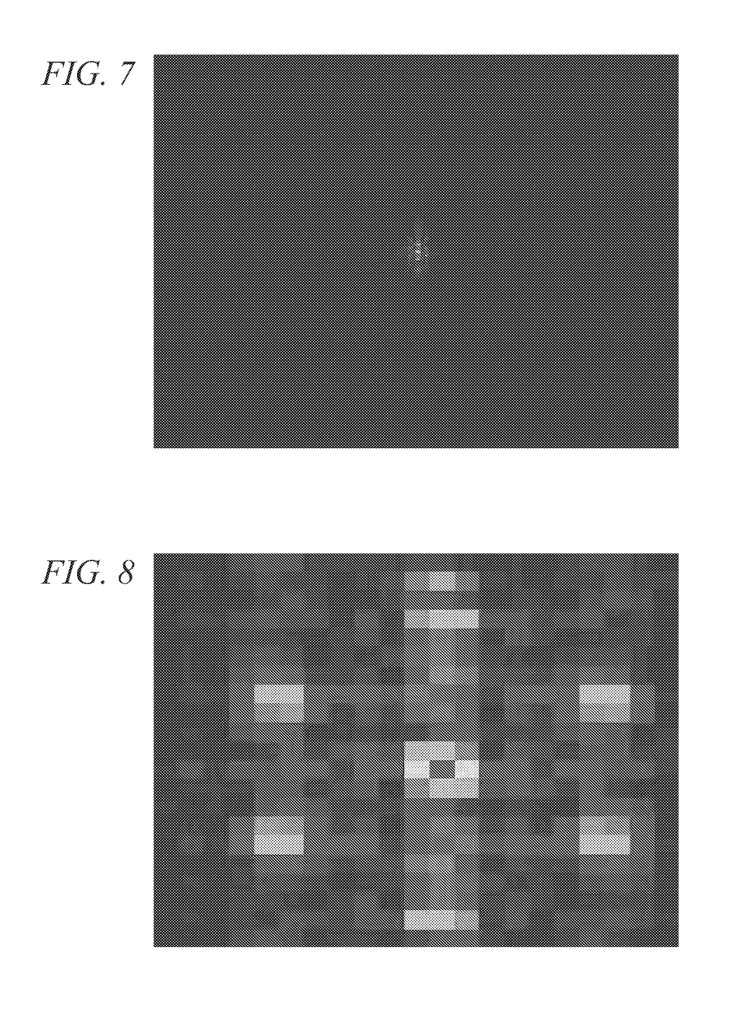

In one embodiment, an input set consists of a clip around known hotspots. FIG. 6 illustrates a hotspot clip in the spatial domain in accordance with an illustrative embodiment. FIG. 7 illustrates a hotspot clip in the frequency domain in accordance with the illustrative embodiment. In accordance with the illustrative embodiment, the frequency domain feature extraction mechanism extracts a feature vector from the center of the diffraction pattern. FIG. 8 illustrates an extracted feature vector in accordance with the illustrative embodiment. The frequency domain feature extraction mechanism extracts a square window of N samples from the diffraction pattern. The value of N is derived empirically and depends on the numerical aperture (NA) of the imaging lens. The total feature vector size is N².

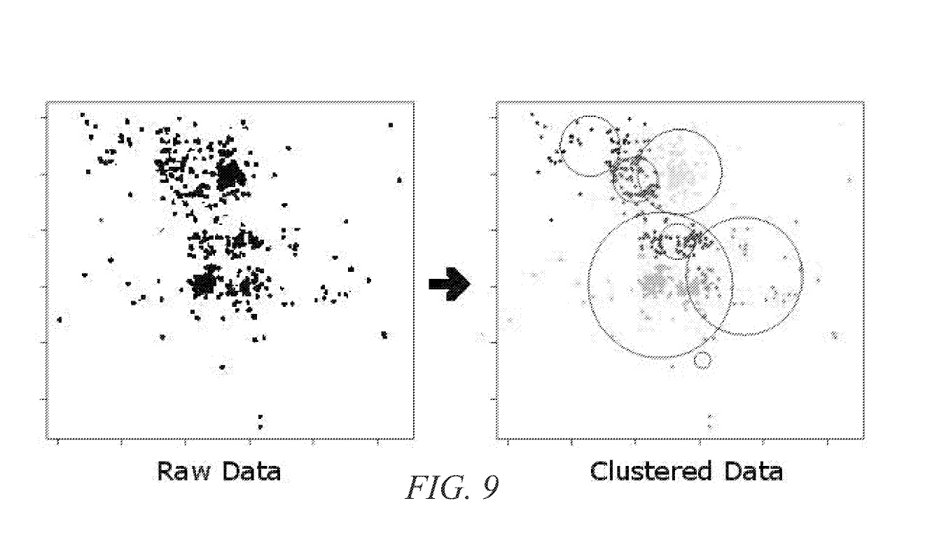

In accordance with another illustrative embodiment, the clustering algorithm uses the extracted feature vectors to cluster hotspot clips. FIG. 9 illustrates raw data being clustered into hotspot clusters in accordance with the illustrative embodiment. Each data point shown in FIG. 9 represents a frequency domain feature vector.

The clustering algorithm uses the feature vectors to cluster hotspot clips. In one example embodiment, the clustering algorithm is a k-means clustering algorithm, which is a method of vector quantization originally from signal processing that is popular for cluster analysis in data mining. The k-means clustering algorithm aims to partition n observations into k clusters in which each observation belongs to the cluster with the nearest mean, serving as a prototype of the cluster.

Given a set of observations (x₁, x₂, . . . , xₙ), where each observation is a d-dimensional real vector (which, in this case is derived from the magnitude of the diffraction orders in the Fourier transform of the pattern), k-means clustering aims to partition the n observations into k sets (k≦n) S={S₁, S₂, . . . , Sₖ} so as to minimize the within-cluster sum of squares (WCSS):

$${arg min}_{S} {\sum }_{i = 1}^{k} {\sum }_{{x}_{j} ∈ {S}_{i}}^{ } {‖ {x}_{j} - {μ}_{i} ‖}^{2} ,$$

where μ₁ is the mean of points in Sᵢ.

The most common algorithm uses an iterative refinement technique. Due to its ubiquity, this algorithm is often called the k-means algorithm; it is also referred to as Lloyds algorithm, particularly in the computer science community. Of course, other variations of the k-means clustering algorithm may be used in the illustrative embodiment. Given an initial set of k means mₗ⁽¹⁾, . . . , mₖ⁽¹⁾, which are usually randomly assigned, the algorithm proceeds by alternating between two steps:

Assignment steps: Assign each observation to the cluster whose mean yields the least within-cluster sum of squares (WCSS). Since the sum of squares is the squared Euclidean distance, this is intuitively the “nearest” mean.

Sᵢ^{(t)}={xₚ:∥xₚ−mᵢ^{(t)}∥²≦∥xₚ−mⱼ^{(t)}∥²∀1≦j≦k},
where each xₚ is assigned to exactly one S^{(t)}, even if it could be is assigned to two or more of them.

Update step: Calculate the new means to be the centroids of the observations in the new clusters.

$${m}_{i}^{( i + 1 )} = \frac{1}{\vert {S}_{i}^{( t )} \vert} {\sum }_{{x}_{j} ∈ {S}_{i}^{( t )}}^{ } {x}_{j}$$

Since the arithmetic mean is a least-squares estimator, this also minimizes the within-cluster sum of squares (WCSS) objective.

The algorithm converges when the assignments no longer change. Since both steps optimize the objective, and there only exists a finite number of such partitions, the algorithm must converge to a (local) optimum. There is no guarantee that the global optimum is found using this algorithm.

The algorithm is often presented as assigning objects to the nearest cluster by distance. This is slightly inaccurate: the algorithm aims at minimizing the WCSS objective, and thus assigns by “least sum of squares.” Using a different distance function other than (squared) Euclidean distance may stop the algorithm from converging. It is correct that the smallest Euclidean distance yields the smallest squared Euclidean distance and thus also yields the smallest sum of squares. Various modifications of k-means such as spherical k-means and k-medoids have been proposed to allow using other distance measures.

Commonly used initialization methods are Forgy and Random Partition. The Forgy method randomly chooses k observations from the data set and uses these as the initial means. The Random Partition method first randomly assigns a cluster to each observation and then proceeds to the update step, thus computing the initial mean to be the centroid of the cluster's randomly assigned points. The Forgy method tends to spread the initial means out, while Random Partition places all of them close to the center of the data set.

As the k-means algorithm is a heuristic algorithm, there is no guarantee that it will converge to the global optimum, and the result may depend on the initial clusters. As the algorithm is usually very fast, it is common to run it multiple times with different starting conditions.

Thus, in the illustrative embodiment, given n ORC layouts and k clusters to determine from the layouts, the mechanism considers the optimization problem to minimize the distance of clips to each of k centroids, which is as follows:

$$arg min {\sum }_{i = 1}^{k} {\sum }_{{x}_{j} ∈ {S}_{i}}^{ } {‖ {x}_{j} - {μ}_{i} ‖}^{2}$$

S={S₁, S₂, . . . Sₖ} represents the set of clusters into which we wish to partition the clips. Each sample xⱼ={xⱼ⁽¹⁾, xⱼ⁽²⁾ . . . , xⱼ^{(m)}} is an m-dimensional vector derived from the frequency domain representation of pattern j. The centroid of each cluster i, derived from the average, is represented by μᵢ. While the embodiment described above uses k-means clustering, other sophisticated clustering algorithms may also be used within the spirit and scope of the present invention.

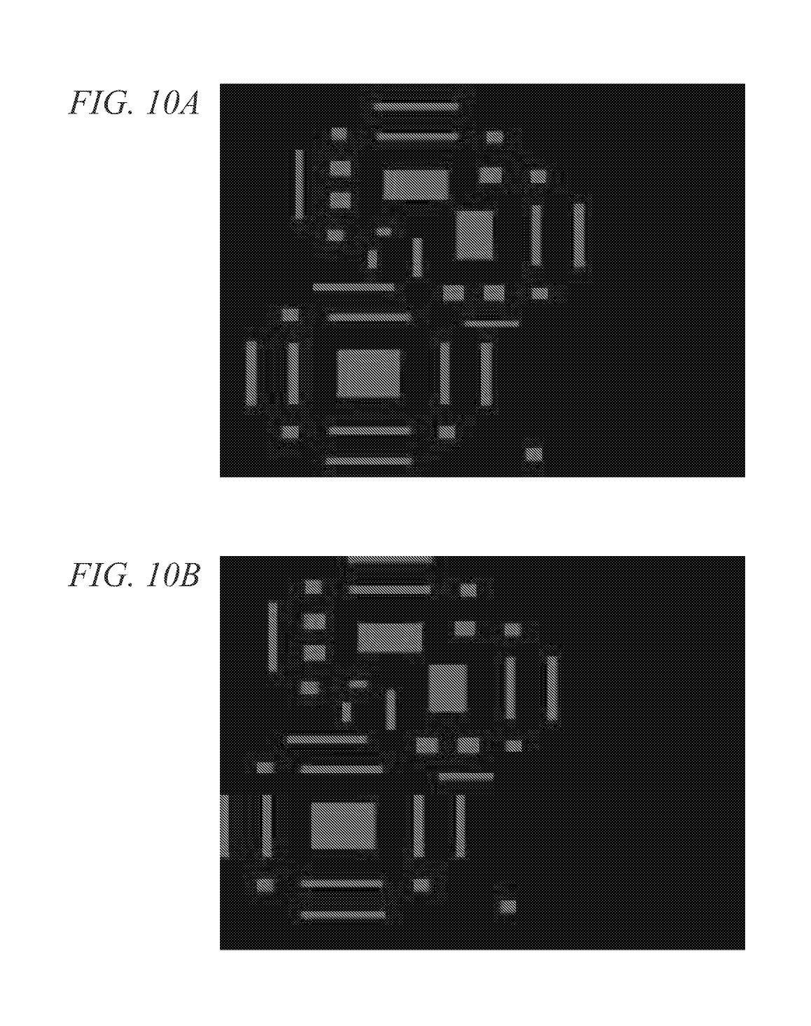

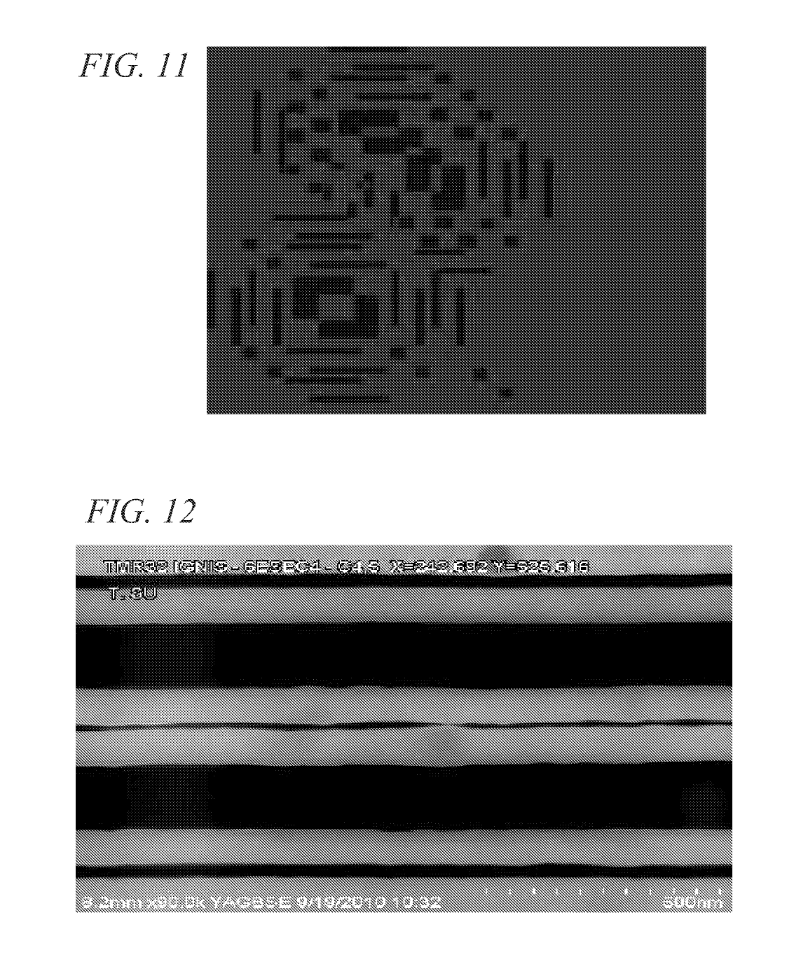

Spatial domain based clustering is highly dependent on clip centering. FIGS. 10A and 10B illustrate a centered hotspot clip and a shifted hotspot clip in accordance with an example embodiment. Slight displacement of the clip window changes spatial feature encoding greatly and affects the clustering model as well. FIG. 11 illustrates an XOR between the centered clip and the shifted clip in accordance with the example embodiment. As seen in FIG. 11, shifting the clip slightly results in a large XOR metric even though it is for the same clip. Frequency based clustering is not only physical but also robust to centering, rotation, and reflection.

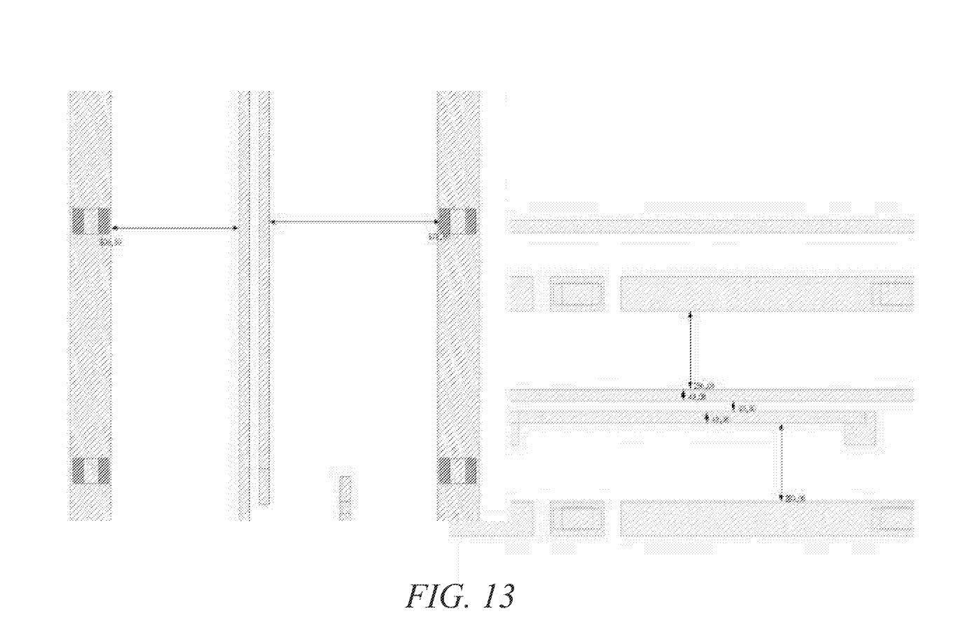

Hotspot clustering may also be used to detect hotspots in new layouts. In accordance with an embodiment, a mechanism computes clusters of known hotspots based on diffraction orders. FIG. 12 illustrates an example of a known hotspot in accordance with an example embodiment. For a given new layout, the mechanism computes a Fast Fourier Transform (FFT) for each clip and applies a distance metric to the resulting feature vector and the centroids of known hotspot clusters. FIG. 13 illustrates an example new layout for which the frequency domain pattern may match the known hotspot in accordance with the example embodiment. If the distance is low (higher similarity) to a cluster, then the clip represents a potential hotspot.

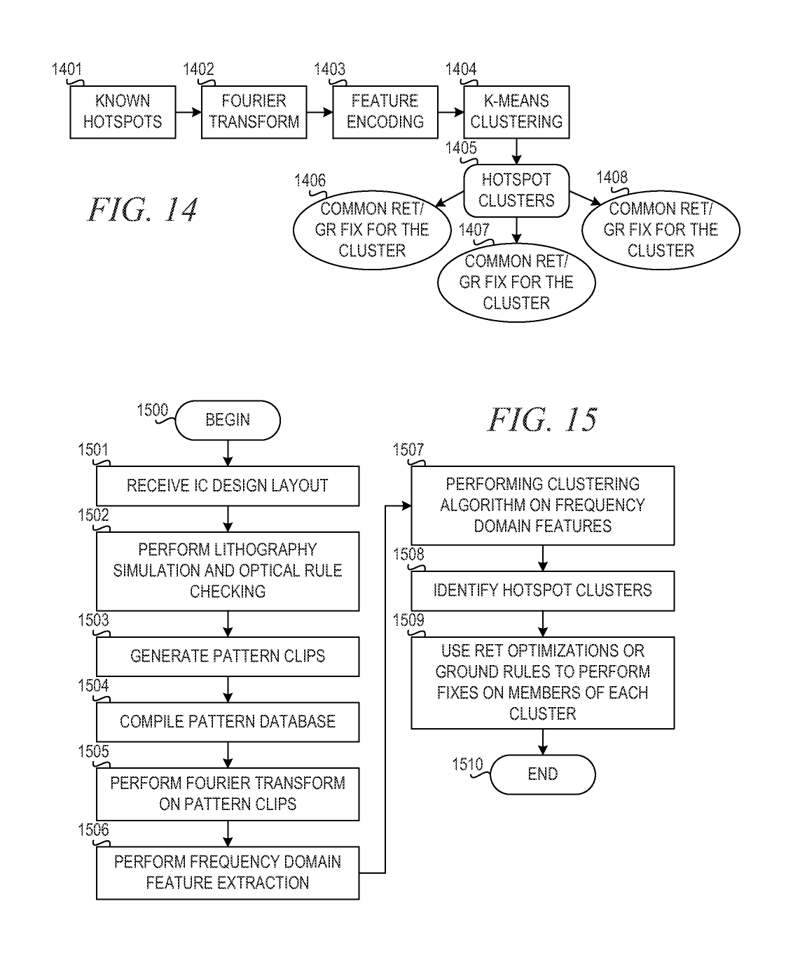

FIG. 14 is a block diagram of a flow for a frequency domain pattern matching mechanism using frequency based clustering in accordance with an illustrative embodiment. The mechanism receives a set of clips in the spatial domain with known hotspots 1401 and performs a Fourier transform 1402. The mechanism then performs feature encoding 1403 and k-means clustering 1404, to generate hotspot clusters 1405. Based on information known about the hotspots, the hotspot clusters 1405 have associated types and fixing actions such as a modification to the resolution enhancement techniques (RET) or ground rules (GR) to outlaw such hotspot clusters from occurring in the design 1406-1408.

For each clip in a new layout, the mechanism may compare the distance of the frequency domain feature and a respective known hotspot cluster to a threshold to determine whether the clip represents a potential hotspot. This technique not only identifies potential hotspots but also the type of hotspot based on the type of known hotspot to which the cluster corresponds. Therefore, if a clip of a new layout matches one of the known hotspot clusters 1405, the mechanism may apply common optical proximity correction (OPC) fixes, such as resolution enhancement technology (RET) or ground rules (GR) fixes 1406-1408, for the cluster to the clip.

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium is a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium is any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Similarly, a computer readable storage medium is any computer readable medium that is not a computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

FIG. 15 is a flowchart illustrating operation of a mechanism for clustering lithographic hotspots based on frequency domain encoding in accordance with an illustrative embodiment. Operation begins (block 1500), and the mechanism receives an IC design layout (block 1501). The mechanism performs lithography simulation and optical rule checking (ORC) (block 1502). The mechanism generates pattern clips (block 1503) and compiles a pattern database (block 1504).

Then, the mechanism performs a Fourier transform on the pattern clips to transform them to the frequency domain (block 1505). The mechanism performs frequency domain feature extraction (block 1506) and performs a clustering algorithm on the frequency domain features (block 1507) to generate a plurality of clusters. The mechanism identifies hotspot clusters within the plurality of clusters (block 1508). The mechanism then uses RET optimization or ground rules to perform fixes on each member of the hotspot clusters (block 1509). Thereafter, operation ends (block 1510).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for clustering lithographic hotspots based on frequency domain encoding. The mechanism performs hotspot clustering based on diffraction orders (spatial frequency) based feature encoding. The frequency based hotspot clustering approach is physically meaningful and robust to shifts in spatial patterns. The mechanisms of the illustrative embodiments can enable a physical flow for identifying and fixing hotspots in a set of layouts instead of ad-hoc per-layout methods. The mechanisms of the illustrative embodiments can enable frequency domain pattern matching for hotspot detection.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for clustering lithographic hotspots based on frequency domain encoding, the method comprising:
receiving a design layout;
generating spatial pattern clips from the design layout;
performing a transform on the spatial pattern clips to form frequency domain pattern clips;
performing feature extraction on the frequency domain pattern clips to form frequency domain features;
clustering the frequency domain features into a plurality of clusters; and
identifying a set of hotspot clusters within the plurality of clusters.

2. The method of claim 1, wherein generating spatial pattern clips comprises performing lithography simulation on the design layout.

3. The method of claim 1, wherein generating spatial pattern clips comprises performing optical rule checking on the design layout.

4. The method of claim 1, wherein the transform is a Fourier transform.

5. The method of claim 1, wherein clustering the frequency domain features comprises performing k-means clustering on the frequency domain features.

6. The method of claim 1, wherein performing feature extraction comprises extracting a square window of N by N samples from a given frequency domain pattern clip, wherein N is based on a numerical aperture of an imaging lens used in a photolithography process.

7. The method of claim 1, wherein the design layout represents clips having known hotspots, the method further comprising:
receiving a new layout to be fabricated;
for a given spatial pattern clip of the new layout, performing a transform on the given spatial pattern clip to form a given frequency domain pattern clip;
performing feature extraction on the given frequency domain pattern clip to form a given frequency domain feature;
determining a distance between the given frequency domain feature and a center of a known hotspot cluster; and
responsive to the distance being less than a threshold, identifying the given spatial pattern clip as a hotspot.

8. The method of claim 7, wherein the known hotspot cluster has a known type.

9. The method of claim 7, wherein the known hotspot cluster has a known correction.

10. The method of claim 9, wherein the known correction comprises an optical proximity correction, a resolution enhancement technology correction, a ground rules fix, or a sub-resolution assist feature correction.

11. A computer program product comprising a computer readable storage medium having a computer readable program stored therein, wherein the computer readable program, when executed on a computing device, causes the computing device to:
receive a design layout;
generate spatial pattern clips from the design layout;
perform a transform on the spatial pattern clips to form frequency domain pattern clips;
perform feature extraction on the frequency domain pattern clips to form frequency domain features;
cluster the frequency domain features into a plurality of clusters; and
identify a set of hotspot clusters within the plurality of clusters.

12. The computer program product of claim 11, wherein generating spatial pattern clips comprises performing lithography simulation on the design layout.

13. The computer program product of claim 11, wherein generating spatial pattern clips comprises performing optical rule checking on the design layout.

14. The computer program product of claim 11, wherein the transform is a Fourier transform.

15. The computer program product of claim 11, wherein clustering the frequency domain features comprises performing k-means clustering on the frequency domain features.

16. The computer program product of claim 11, wherein performing feature extraction comprises extracting a square window of N by N samples from a given frequency domain pattern clip, wherein N is based on a numerical aperture of an imaging lens used in a photolithography process.

17. The computer program product of claim 11, wherein the design layout represents clips having known hotspots, wherein the computer readable program further causes the computing device to:
receiving a new layout to be fabricated;
for a given spatial pattern clip of the new layout, performing a transform on the given spatial pattern clip to form a given frequency domain pattern clip;
performing feature extraction on the given frequency domain pattern clip to form a given frequency domain feature;
determining a distance between the given frequency domain feature and a center of a known hotspot cluster; and
responsive to the distance being less than a threshold, identifying the given spatial pattern clip as a hotspot.

18. The computer program product of claim 17, wherein the known hotspot cluster has a known correction.

19. The computer program product of claim 18, wherein the known correction comprises an optical proximity correction, a resolution enhancement technology correction, a ground rules fix, or a sub-resolution assist feature correction.

20. An apparatus comprising:
a processor; and
a memory coupled to the processor, wherein the memory comprises instructions which, when executed by the processor, cause the processor to:
receive a design layout;
generate spatial pattern clips from the design layout;
perform a transform on the spatial pattern clips to form frequency domain pattern clips;
perform feature extraction on the frequency domain pattern clips to form frequency domain features;
cluster the frequency domain features into a plurality of clusters; and
identify a set of hotspot clusters within the plurality of clusters.
